(19) United States
(12) Patent Application Publication
(10) Pub. No.: US 2026/0230682 A1
(43) Pub. Date: Aug. 6, 2026

(54) VIDEO TRANSMISSION METHOD AND APPARATUS, AND ELECTRONIC DEVICE AND COMPUTER STORAGE MEDIUM

(71) Applicant: SHENZHEN TCL NEW TECHNOLOGY CO., LTD., Shenzhen, Guangdong (CN)

(72) Inventors: Yangqin CHEN, Shenzhen, Guangdong (CN); Naiwen WANG, Shenzhen, Guangdong (CN)

(73) Assignee: SHENZHEN TCL NEW TECHNOLOGY CO., LTD., Shenzhen, Guangdong (CN)

(21) Appl. No.: 19/152,931

(22) PCT Filed: Jan. 8, 2024
(86) PCT No.: PCT/CN2024/071072

§ 371 Date: Jul. 31, 2025

(30) Foreign Application Priority Data
Feb. 1, 2023 (CN) 202310125106.3

(51) Int. Cl. H04N 21/647; H04N 23/661

(52) U.S. Cl. CPC H04N 21/64715; H04N 23/661

(57) ABSTRACT

This application discloses a video transmission method and apparatus, and electronic device and computer storage medium; the video transmission method comprising: through a target application in the control device, adding a camera to a target network where the control device is located; based on a matter protocol, sending a signaling acquisition request to the camera through the target application, so that the camera obtains a first signaling data of the camera from a matter data model of the camera based on the signaling acquisition request; receiving the first signaling data returned by the camera through the target network; through the target application, sending the second signaling data of the control device to the camera according to the first signaling data, so that the camera transmits a captured video to the target application through the target network according to the second signaling data.

The International application claims the priority of a Chinese patent application with the application date of Feb. 1, 2023, application number 202310125106.3, and invention name “VIDEO TRANSMISSION METHOD AND APPARATUS, AND ELECTRONIC DEVICE AND COMPUTER STORAGE MEDIUM”, and the whole content is incorporated herein by reference.

### TECHNICAL FIELD

The present application relates to the field of camera technologies, and specifically to a video transmission method and apparatus, and electronic device and computer storage medium.

### BACKGROUND ART

With the advancement of science and technology, cameras have become increasingly intelligent, allowing users to view captured videos through applications.

Before the video captured by the camera is obtained through the application, signaling interaction between the application and the camera must be conducted through a cloud server, resulting in a low speed of obtaining the video captured by the camera through the application.

### TECHNICAL CHALLENGE

This application can solve the technical problem of the low speed of obtaining the video captured by the camera through the application.

### TECHNICAL SOLUTION

The present application provide a video transmission method, comprising:
through a target application in the control device, adding a camera to a target network where the control device is located;
based on a matter protocol, sending a signaling acquisition request to the camera through the target application, so that the camera obtains a first signaling data of the camera from a matter data model of the camera based on the signaling acquisition request;
receiving the first signaling data returned by the camera through the target network;
through the target application, sending the second signaling data of the control device to the camera according to the first signaling data, so that the camera transmits a captured video to the target application through the target network according to the second signaling data.

Correspondingly, the present application provide another video transmission method, comprising:
though a target network, receiving a signaling acquisition request sent by the control device based on the matter protocol through a target application in the control device;
based on the signaling acquisition request, acquiring the first signaling data of the camera from the matter data model of the camera;
returning the first signaling data to the target application through the target network;
through the target network, receiving the second signaling data of the control device returned by the control device through the target application according to the first signaling data;
according to the second signaling data, transmitting the captured video to the target application through the target network.

Correspondingly, the present application provide a video transmission device, comprising:
a network adding module, which is used to through a target application in the control device, add a camera to a target network where the control device is located;
a first sending module, which is used to based on a matter protocol, send a signaling acquisition request to the camera through the target application, so that the camera obtains a first signaling data of the camera from a matter data model of the camera based on the signaling acquisition request;
a first receiving module, which is used to receive the first signaling data returned by the camera through the target network;
a second sending module, which is used to through the target application, send the second signaling data of the control device to the camera according to the first signaling data, so that the camera transmits a captured video to the target application through the target network according to the second signaling data.

Correspondingly, the present application provide another video transmission device, comprising:
a second receiving module, which is used to receive a signaling acquisition request sent by the control device through the target network and based on the matter protocol and through the target application in the control device;
a data reading module, which is used to obtain the first signaling data of the camera from the matter data model of the camera based on the signaling acquisition request;
a data return module, which is used to transmit the first signaling data back to the target application through the target network;
a third receiving module, which is used to receive the second signaling data of the control device returned by the control device through the target application according to the first signaling data via the target network;
the video transmission module, which is used to transmit the captured video to the target application through the target network according to the second signaling data.

In addition, the present application also provide an electronic device, comprising a processor and a memory, wherein the memory stores a computer program, and the processor is used to run the computer program in the memory to implement the video transmission method provided by the present application.

In addition, the present application also provide a computer-readable storage medium, the computer-readable storage medium storing a computer program, the computer program being adapted to be loaded by a processor to perform any of the video transmission methods provided by the present application.

In addition, the present application also provide a computer program product, comprising a computer program that, when executed by a processor, implements any of the video transmission methods provided by the present application.

### EXPECTED BENEFIT

In the embodiments of this application, adding the camera to the target network where the control device is located through the target application in the control device. Based on the matter protocol, the target application sends a signaling acquisition request to the camera, enabling the camera to retrieve its first signaling data from the matter data model of the camera in response to the signaling acquisition request. The camera then receives this first signaling data via the target network. Using the target application, the control device transmits second signaling data of the control device to the camera based on the first signaling data, enabling the camera to transmit the captured video to the target application via the target network based on the second signaling data.

In this application, the camera's first signaling data is stored in the matter data model. When both the camera and control device are within the target network and the control device sends a signaling request to the camera via the target application based on the matter protocol, the camera can directly return the first signaling data to the control device. This allows the control device to send its second signaling data to the camera through the target application using the first signaling data. Consequently, the camera transmits the captured video to the target application via the target network using the second signaling data. This eliminates the need for cloud servers to send both signaling data, thereby enhancing the transmission speed of these two signaling data streams and ultimately improving the efficiency of video acquisition.

### DESCRIPTION OF DRAWINGS

To better illustrate the technical solutions in this application, we will briefly introduce the accompanying drawings used in the description below. It should be noted that these drawings merely limited to the application. For those technical staff, additional diagrams can be derived from these illustrations without requiring inventive effort.

FIG. 1 is a flow diagram of the video transmission method provided by the present application;

FIG. 2 is a schematic diagram of the matter data model provided by the present application;

FIG. 3 is a flow diagram of another video transmission method provided by the present application;

FIG. 4 is a flow diagram of another video transmission method provided by the present application;

FIG. 5 is a flow diagram of another video transmission method provided by the present application;

FIG. 6 is a schematic diagram of the structure of the video transmission device provided in the present application;

FIG. 7 is a schematic diagram of the structure of another video transmission device provided in the present application;

FIG. 8 is a schematic diagram of the structure of the electronic device provided in the present application.

### DETAILED DESCRIPTION OF EMBODIMENTS

Embodiments of the application are described in detail with the technical matters, structural features, achieved objects, and effects with reference to the accompanying drawings as follows. Specifically, the terminologies in the embodiments of the present application are merely for describing the purpose of the certain embodiment, but not to limit the application.

In this document, the term “/” should be interpreted to indicate “and/or.” A combination such as “at least one of A, B, or C,” “one or more of A, B, or C,” “at least one of A, B, and C,” “one or more of A, B, and C,” or “A, B, and/or C” may be A only, B only, C only, A and B, A and 30 C, B and C, or A and B and C, where any combination may contain one or more members of A, B, or C.

The technical solutions in the embodiments of the present application will be described clearly and comprehensively below with reference to the accompanying drawings. It should be understood that the described embodiments represent only a portion of the embodiments of this application, rather than all possible implementations. All other embodiments obtained by those skilled in the art based on the embodiments of this application without creative efforts shall fall within the protection scope of this application.

The embodiments of the present application provide a video transmission method, device, electronic device and computer storage medium. The video transmission apparatus can be integrated in an electronic device, which can be a control device or a camera.

Among them, the control device may be a server or a terminal device. The server may be an independent physical server, a server cluster or distributed system composed of multiple physical servers, or a cloud server providing fundamental cloud computing services including but not limited to: cloud services, cloud databases, cloud computing, cloud functions, cloud storage, network services, cloud communications, middleware services, domain name services, security services, content delivery network (CDN) acceleration services, as well as big data and artificial intelligence platforms.

The terminal device may be a smart phone, tablet computer, laptop computer, desktop computer, smart speaker, smart watch, etc., but is not limited to this. The terminal device and the server may be directly or indirectly connected through wired or wireless communication, which is not restricted by the application herein.

Additionally, in the embodiments of the present application, “a plurality of” refers to two or more. The terms “first” and “second” used in the embodiments are for distinguishing descriptions only and should not be construed as indicating relative importance.

The following will be described in detail. It should be noted that the order of description of the following embodiments is not intended to limit the preferred order of the embodiments.

In this embodiment, the video transmission device will be described. In order to facilitate the description of the video transmission method of the present application, the following will describe in detail the video transmission device integrated in the control device, that is, the control device is taken as the execution body for detailed description.

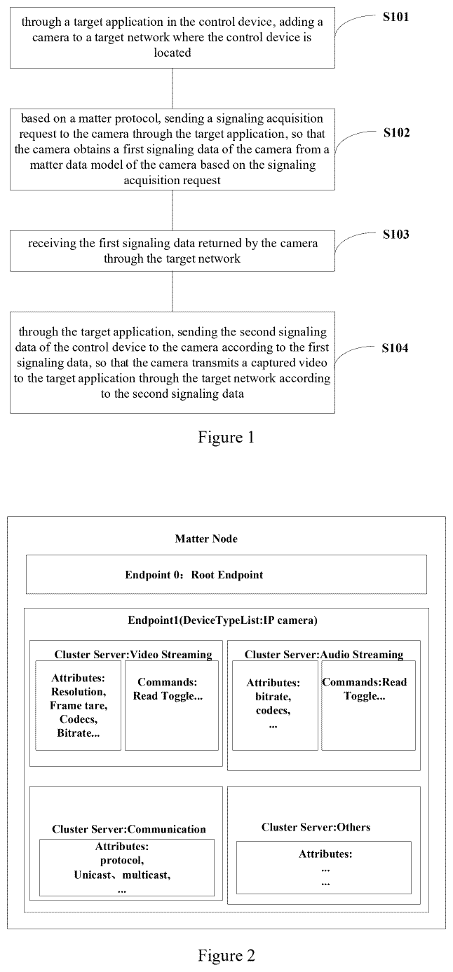

Please refer to FIG. 1, which is a flow diagram of the video transmission method provided by an embodiment of the present application. The video transmission method may include:

S101. through a target application in a control device, adding a camera to a target network where the control device is located.

The control device can first obtain the camera's device information, then add the corresponding camera to the target network of the control device based on this information. The method for obtaining the camera's device information can be selected according to actual conditions. For example, the camera may broadcast its own device information, which the control device can then scan through the target application. Alternatively, the camera's device information could be stored in a QR code, allowing the control device to retrieve it by scanning the code. This application does not limit itself to these methods.

In some embodiments, in order to ensure security, by the target application in the control device, the camera is added to the target network of the control device, including:

Through the target application in the control device, send the certificate acquisition request to the camera;

Receive the target certificate returned by the camera in response to the certificate acquisition request;

If the target certificate is verified, adding the camera to the target network where the control device is located.

Among them, the target certificate refers to a digital certificate that indicates the identity information of the camera, which can be a digital certificate issued to the camera by the matter platform after authenticating the camera. In this case, the control device can also be called the Commissioner, and the camera can be called the Commissioned Device.

Upon obtaining the target certificate, the control device can verify it using the private key in the target application. Since matter Platform serves as the trusted third-party authority for the control device, passing this verification confirms that the matter Platform trusts the camera. This means the control device can trust the camera, indicating its security. Consequently, the camera can be added to the target network of the control device, thereby enhancing security. It should be noted that after adding the camera to the target network, if the control device reconnects to the network after disconnection, the camera remains connected. When the control device reconnects, both the control device and the camera will be on the same network, eliminating the need to re-add the camera to the target network.

S102. based on a matter protocol, sending a signaling acquisition request to the camera through the target application, so that the camera obtains a first signaling data of the camera from a matter data model of the camera based on the signaling acquisition request.

The matter protocol is an application layer protocol launched by the Connectivity Standards Alliance (CSA), which enables smart devices from different brands and ecosystems to break down barriers and achieve interconnection.

The matter data model serves as a storage mechanism for device functions. In this application scenario, the camera's primary signaling data can be stored within the matter data model. When receiving signaling requests from control devices via the matter protocol, the camera retrieves this primary signaling data from its matter data model and directly transmits it to target applications. This approach enables seamless operation within the target network (where both the control device and camera reside in the same LAN), eliminating the need for cloud server intermediaries. By reducing transmission latency, this methodology significantly enhances video streaming performance.

First signaling data refers to the control information required to obtain video captured by the camera through the target application. For example, first signaling data may include at least one of the audio and video streaming media encoding formats supported by the camera, sampling rate, frame rate, LAN IP and port, and public IP and port.

The target application developer and camera manufacturer can be the same or different entities. Since both applications and cameras can undergo matter platform authentication, the platform simultaneously serves as a trusted third-party authority for both. This allows the target application developer and camera manufacturer to operate independently, enabling cross-platform video viewing through a single application and achieving cross-ecosystem camera control.

In some embodiments, based on the matter protocol, signaling acquisition requests are sent to the camera through the target application, so that the camera obtains first signaling data from the matter data model of the camera based on the signaling acquisition requests, including:

Based on the matter protocol, the target application sends signaling to obtain requests to the camera, so that the camera can read the first signaling data from the attribute module of the matter data model based on the signaling request through the behavior module of the matter data model.

In this embodiment of the application, the reading operation is stored in the behavior module of the matter data model, while the first signaling data is stored in the attribute module. This configuration enables the camera to retrieve its first signaling data from the attribute module through the behavior module of the matter data model, based on the received signaling request.

For example, the matter data model for cameras can be illustrated in FIG. 2. The matter Node represents the camera itself, while Endpoints denote its logical components that describe functional capabilities. ClusterServers specifically characterize individual camera functions. For instance, a camera may include three distinct ClusterServers: Video Streaming (for video transmission), Audio Streaming (for audio transmission), and Communication (for connectivity).

The Attributes module represents the camera's signaling data storage. For example, in Video Streaming, Attributes store resolution, frame rate, codec, and bitrate. In Audio Streaming, Attributes store codec and bitrate parameters. The Communication module contains protocol, unicast address, and multicast address configurations. Additionally, the Behavior module stores various camera operations such as read and toggle commands.

S103. receiving the first signaling data returned by the camera through the target network.

After obtaining the first signaling data, the camera can return the first signaling data to the target application through the target network, so that the control device can obtain the first signaling data.

S104. through the target application, sending the second signaling data of the control device to the camera according to the first signaling data, so that the camera transmits a captured video to the target application through the target network according to the second signaling data.

The second signaling data refers to the control information required by the camera to transmit the video. The second signaling data may include at least one of the audio and video streaming media encoding formats supported by the control device, sampling rate, frame rate, LAN IP and port, and public IP and port.

Since the control device has already obtained the first signaling data through the matter protocol, it can directly send the second signaling data to the camera via the target application based on this data. The camera then transmits the captured video to the target application through the network using the second signaling data. This approach allows the control device to access the video footage without reacquiring the first signaling data, thereby significantly improving the transmission speed of the first frame in the captured video.

In some embodiments, the control device's second signaling data is sent to the camera via the target application according to the first signaling data, so that the camera transmits the captured video to the target application through the target network according to the second signaling data, including:

Through the target application, a streaming media transmission request is generated based on the second signaling data of the control device;

According to the first signaling data, the streaming media transmission request is sent to the camera so that the camera transmits the captured video to the target application through the target network according to the second signaling data in the streaming media transmission request.

A streaming media transmission request refers to a request processed through the streaming media transmission protocol, which provides real-time end-to-end delivery of streaming data. The type of streaming media transmission protocol can be selected based on practical requirements, such as Real-Time Streaming Protocol (RTSP) or Secure Real-Time Transport Protocol (SRTP). This application's embodiments do not impose specific limitations on these protocols.

Optionally, a streaming media transmission request may include not only the second signaling data but also a streaming media transmission port (e.g., when RTP is the streaming media transmission protocol, the streaming media transmission port may be a RTP port), a unicast mode, and a connection mode (the connection mode may be either connectionless or connected, where connectionless may be implemented using UDP).

In this embodiment of the application, the target application generates a streaming media transmission request based on the control device's second signaling data. Subsequently, using the first signaling data, the system transmits the second signaling data to the camera via the streaming media request. This enables the camera to transmit captured video through the target network to the target application, thereby reducing latency in video transmission to the application.

In other embodiments, before the control device's second signaling data is sent to the camera via the target application based on the first signaling data, it further includes:

Store first signaling data through matter interaction model;

Through the target application, sending the second signaling data of the control device to the camera according to the first signaling data, so that the camera transmits the captured video to the target application through the target network according to the second signaling data, including:

Determine whether the control device and camera are in the target network;

If the control device and camera are in the target network, reading the first signaling data from the matter interaction model;

Through the target application, sending the second signaling data of the control device to the camera according to the first signaling data, so that the camera transmits the captured video to the target application through the target network according to the second signaling data.

In this embodiment of the application, since the camera's first signaling data is fixed, the control device can store this data in the matter Interaction Model upon acquisition. This allows the device to directly retrieve the first signaling data from the model when reconnecting with the target network after disconnection, eliminating the need to reacquire it from the camera. This approach significantly enhances the speed of obtaining first signaling data, thereby improving the transmission efficiency of video captured by the camera.

Optionally, if the control device is not in the target network and the camera is in the target network, signaling data can be transmitted between the control device and the camera through WebRTC technology, that is, signaling data can be transmitted through a cloud server.

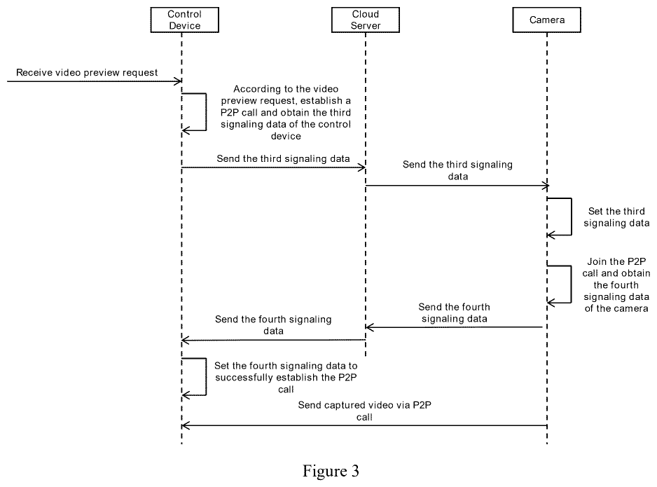

Optionally, the process of transmitting signaling data through WebRTC technology can be (see FIG. 3) as follows:

The control device receives video preview requests and establishes P2P calls based on these requests. It acquires third-party signaling data from the control device, which is then transmitted to the cloud server. The cloud server subsequently sends this data to the camera. After receiving the third-party signaling data, the camera configures it and joins the P2P call while obtaining fourth-party signaling data. This fourth-party signaling data is sent from the camera to the cloud server, which relays it back to the control device. The control device then configures the fourth-party signaling data to successfully establish the P2P call. Through this P2P connection, the camera transmits captured video streams to the control device.

In other embodiments, the control device's second signaling data is sent to the camera via the target application based on the first signaling data, so that the camera transmits the captured video to the target application via the target network according to the second signaling data, including:
acquiring the signaling identifier corresponding to the second signaling data of the control device;

Through the target application, sending the signaling identifier to the camera according to the first signaling data, so that the camera can determine the second signaling data corresponding to the signaling identifier, and transmit the captured video to the target application through the target network according to the second signaling data.

In this embodiment of the application, since the control device generates multiple signaling data types, the camera can store both the second signaling data and its corresponding signaling identifier upon receiving it. This allows the control device to subsequently transmit only the signaling identifier of the second signaling data to the camera. The camera then determines the current signaling data based on this identifier, which reduces the amount of transmitted data while further enhancing signaling data transmission speed. Consequently, this approach significantly improves video transmission efficiency.

It should be understood that if there are multiple types of signaling data in the control device, the camera can associate and store each type of signaling data and the signaling identifier of the signaling data after obtaining the signaling data from the control device.

In other embodiments, the control device's second signaling data is sent to the camera via the target application based on the first signaling data, so that the camera returns a response information to the target application via the target network based on the second signaling data;

Verify the response information through the target application;

If the verification is passed, the confirmation information is returned to the camera so that the camera can transmit the captured video to the target application through the target network according to the confirmation information.

To ensure secure data transmission, the camera first sends a response message containing the streaming media port and the port for transmitting second signaling data to the target application based on the first signaling data. Upon receiving this response, the control device compares it with preset parameters. If identical, the device verifies the response's validity and then returns an acknowledgment to the camera.

Optionally, the decision to require cameras to send response information back to control devices can be determined based on their application scenarios. For instance, in high-security environments where confidentiality is paramount, it may be necessary for cameras to transmit feedback to control devices. Conversely, in less sensitive applications, this communication requirement could be omitted.

Optionally, after the camera returns the response information to the target application, it can also directly transmit the captured video to the target application. In this case, there is no need to wait for the confirmation information to be obtained before transmitting the captured video to the target application.

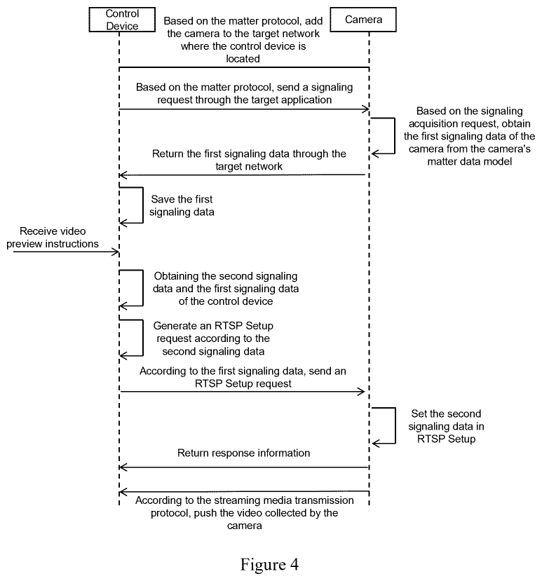

As illustrated in FIG. 4, when a control device is connected to the target network via a matter protocol-based application, it can send signaling requests to the camera through the same protocol. The camera then retrieves its first signaling data from the matter data model and transmits this information back to the application via the network. The control device subsequently saves this initial signaling data.

When the control device receives a video preview command through the target application, it first determines whether the device is within the target network. If the device is confirmed to be in the network, it retrieves both the second signaling data and first signaling data. Based on the second signaling data, the system generates an RTSP Setup request, which is then sent to the camera using the first signaling data. Upon receiving this request, the camera configures the second signaling data in the RTSP Setup process, returns a response to the control device, and finally pushes the captured video stream to the target application according to the streaming media transmission protocol.

As described above, in the embodiments of this application, the camera is integrated into the target network of the control device by controlling its target application. Through the matter protocol, the target application sends signaling requests to the camera, enabling it to retrieve first signaling data from its matter data model. The camera then receives this data via the target network. Subsequently, the target application transmits second signaling data from the control device to the camera, which subsequently transmits captured video streams to the target application through the network based on this signaling data.

In the embodiments of this application, the camera's first signaling data is stored in the matter data model. When both the camera and control device are within the target network and the control device sends a signaling request to the camera via the target application based on the matter protocol, the camera can directly return the first signaling data to the control device. This allows the control device to send its second signaling data to the camera through the target application using the first signaling data. Consequently, the camera transmits the captured video to the target application via the target network using the second signaling data. This eliminates the need for cloud servers to send both signaling data, thereby enhancing the transmission speed of these two signaling data streams and ultimately improving the efficiency of video acquisition.

The following provides another video transmission method provided by an embodiment of the present application. In this embodiment, in order to facilitate the description of the video transmission method of the present application, the following will be described in detail with reference to the camera in which the video transmission device is integrated, that is, the camera is taken as the execution body for detailed description.

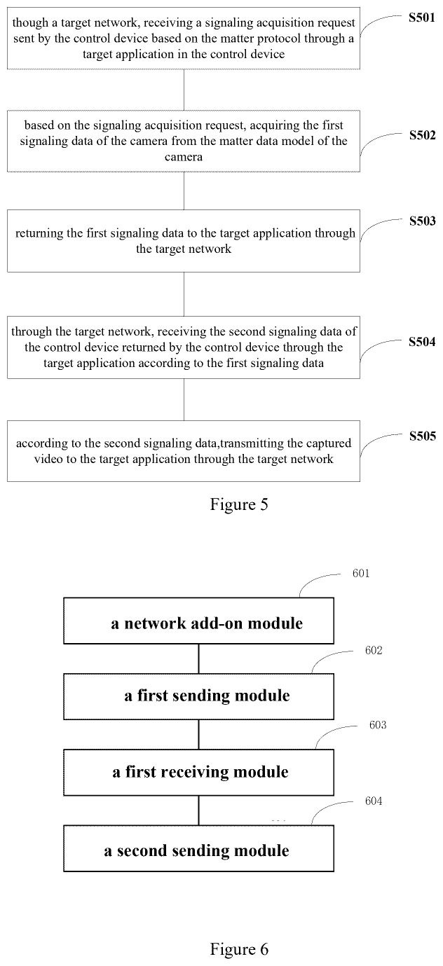

Please refer to FIG. 5, which is a flow diagram of another video transmission method provided by an embodiment of the present application. The video transmission method may include:

S501. though a target network, receiving a signaling acquisition request sent by the control device based on the matter protocol through a target application in the control device ;.

Since the target network is the network where the camera is located, the camera can receive requests through the target network and obtain signaling sent by the control device based on the matter protocol through the target application in the control device.

If the camera is not connected to the target network, the camera can receive the network information sent by the control device through the target application, and then send a connection request to the target network corresponding to the network information, so that the target network can establish a connection with the camera based on the connection request.

Optionally, the camera may send an authentication request to the matter platform for verification. If the authentication is successful, the matter platform will transmit the target certificate to the camera, which then stores it. This allows the camera to forward the certificate to the control device when receiving a certificate retrieval request from the control device.

S502. based on the signaling acquisition request, acquiring the first signaling data of the camera from the matter data model of the camera.

The matter data model can be used for the functions of the storage device. Therefore, in this application example, the first signaling data of the camera can be stored in the matter data model, so that when the camera receives a signaling acquisition request sent by the control device based on the matter protocol, the first signaling data can be read from the matter data model of the camera.

In some embodiments, based on the signaling acquisition request, the first signaling data of the camera is obtained from the matter data model of the camera, including:

Based on the signaling acquisition request, the first signaling data of the camera is read from the attribute module of the matter data model through the behavior module of the matter data model.

In this embodiment, the camera's signaling acquisition process is structured as follows: The behavior module of the matter Data Model handles signaling request processing, while the attribute module manages signaling data storage. When a signaling request is received, the camera utilizes its Behavior Module to retrieve the first signaling data from the attribute module within the matter Data Model.

S503. returning the first signaling data to the target application through the target network.

After the camera reads the first signaling data from the matter data model of the camera, the first signaling data can be directly sent to the target application through the target network without sending the first signaling data through the cloud server, so as to improve the transmission speed of the first signaling data and further improve the subsequent video transmission speed.

S504. through the target network, receiving the second signaling data of the control device returned by the control device through the target application according to the first signaling data.

S505. according to the second signaling data, transmitting the captured video to the target application through the target network.

In this embodiment of the application, the camera's first signaling data is stored in a matter protocol data model. This allows the camera to retrieve the first signaling data from its matter data model and directly transmit it to the target application when receiving a signaling request from a control device via the matter protocol. This innovation eliminates the need for transmitting the first signaling data to the control device during video transmission. Instead, upon receiving the second signaling data, the camera can immediately use it to send captured video streams through the target network to the application. This approach significantly enhances the transmission speed of the first frame in video recordings captured by the camera.

In some embodiments, the receiving control device returns control device second signaling data based on the first signaling data via the target network, and transmits the captured video to the target application via the target network based on the second signaling data, including:

Through the target network, the receiving control device receives the signaling identifier corresponding to the second signaling data of the control device returned by the target application based on the first signaling data;

Determining the second signaling data corresponding to the signaling identifier;

According to the second signaling data, transmitting the collected video to the target application through the target network.

In this embodiment of the application, since the control device generates multiple signaling data types, the camera can store both the second signaling data and its corresponding signaling identifier upon receiving it. This allows the control device to subsequently transmit only the signaling identifier of the second signaling data to the camera. The camera then determines the current signaling data based on this identifier, which reduces the amount of transmitted data while further enhancing signaling data transmission speed. Consequently, this approach significantly improves video transmission efficiency.

The specific implementation method of the embodiments of the present application and the corresponding beneficial effects can be specifically referred to the above video transmission method embodiment, and the embodiments of the present application will not be described again here.

To facilitate the better implementation of the video transmission method provided in the embodiments of the present application, the embodiments of the present application also provide an apparatus based on the video transmission method. The meanings of terms are the same as those in the video transmission method, and specific implementation details can be referred to the description in the method embodiment.

For example, as shown in FIG. 6, the video transmission device may include:
a network add module 601, which is used to through a target application in the control device, add a camera to a target network where the control device is located.
a first sending module 602, which is used to based on a matter protocol, send a signaling acquisition request to the camera through the target application, so that the camera obtains a first signaling data of the camera from a matter data model of the camera based on the signaling acquisition request.
a first receiving module 603, which is used to receive the first signaling data returned by the camera through the target network
a second sending module 604, which is used to through the target application, send the second signaling data of the control device to the camera according to the first signaling data, so that the camera transmits a captured video to the target application through the target network according to the second signaling data.

Optionally, the first transmitting module 602 is specifically used for performing:
based on the matter protocol, sending the signaling acquisition request to the camera through the target application, so that the camera, based on the signaling acquisition request, reads the first signaling data of the camera from a attribute module of the matter data model through a behavior module of the matter data model.

Optionally, the second transmitting module 604 is specifically used for performing:
through the target application, generating a streaming media transmission request based on the second signaling data of the control device;
according to the first signaling data, sending the streaming media transmission request to the camera so that the camera transmits the captured video to the target application through the target network according to the second signaling data in the streaming media transmission request.

Optionally, the video transmission device further includes:
the storage module is used to store the first signaling data through the matter interaction model.

Correspondingly, the second transmitting module 604 is specifically used for performing:
determine whether the control device and the camera are in the target network;
if the control device and the camera are in the target network, reading the first signaling data from the matter interaction model;
through the target application, sending the second signaling data of the control device to the camera according to the first signaling data, so that the camera transmits the captured video to the target application through the target network according to the second signaling data.

Optionally, the second transmitting module 604 is specifically used for performing:
acquiring the signaling identifier corresponding to the second signaling data of the control device;
through the target application, sending the signaling identifier to the camera according to the first signaling data, so that the camera can determine the second signaling data corresponding to the signaling identifier, and transmit the captured video to the target application through the target network according to the second signaling data.

Optionally, the second transmitting module 604 is specifically used for performing:
through the target application, sending the second signaling data of the control device to the camera according to the first signaling data, so that the camera returns the response information to the target application through the target network according to the second signaling data;
verifying the response information by the target application;
if the verification is passed, the confirmation information is returned to the camera so that the camera can transmit the captured video to the target application through the target network according to the confirmation information.

Optionally, the network adding module 601 is specifically used for performing:
through the target application in the control device, sending a certificate acquisition request to the camera;
the receiving camera receives the target certificate returned by the certificate acquisition request;
if the verification of the target certificate is passed, adding the camera to the target network where the control device is located.

In the specific implementation, the above-mentioned modules can be implemented as independent entities, or they can be combined arbitrarily to implement one or several entities. The specific implementation methods of the above-mentioned modules and the corresponding beneficial effects can be seen in the previous method embodiment, and will not be repeated here.

To facilitate better implementation of the video transmission method provided by embodiments of the present application, the embodiments of the present application also provide another apparatus based on the video transmission method. The meanings of terms are the same as those in the video transmission method, and specific implementation details can be referred to the description in the method embodiment.

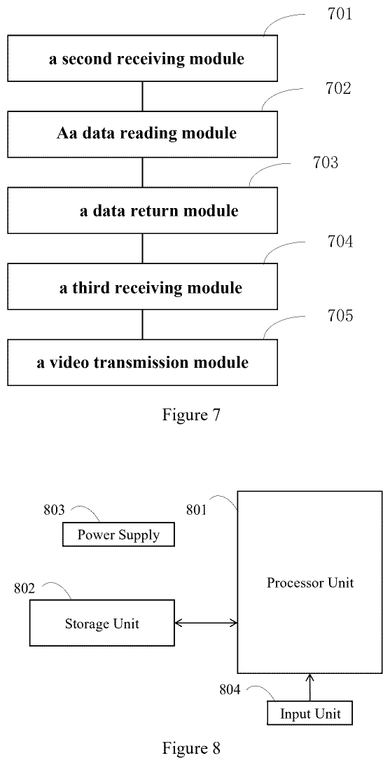

For example, as shown in FIG. 7, the video transmission device may include:

The second receiving module 701 is used to though a target network, receive a signaling acquisition request sent by the control device based on the matter protocol through a target application in the control device.

The data reading module 702 is used to based on the signaling acquisition request, acquiring the first signaling data of the camera from the matter data model of the camera.

Data return module 703 is used to return the first signaling data to the target application through the target network.

The third receiving module 704 is used to through the target network, receive the second signaling data of the control device returned by the control device through the target application according to the first signaling data.

Video transmission module 705 is used to according to the second signaling data, transmitting the captured video to the target application through the target network.

Optionally, the data reading module 702 is specifically used for performing:
based on the signaling acquisition request, reading the first signaling data of the camera from the attribute module of the matter data model of the camera through the behavior module of the matter data model.

Optionally, the video transmission module 705 is specifically used for performing:
receiving a signaling identifier corresponding to the second signaling data of the control device returned by the control device through the target application according to the first signaling data;
determining the second signaling data corresponding to the signaling identifier;
according to the second signaling data, transmitting the captured video to the target application through the target network.

In the specific implementation, the above-mentioned modules can be implemented as independent entities, or they can be combined arbitrarily to implement one or several entities. The specific implementation methods of the above-mentioned modules and the corresponding beneficial effects can be seen in the previous method embodiment, and will not be repeated here.

The embodiments of the present application also provide an electronic device, which can be a server or terminal, etc. As shown in FIG. 8, it shows the schematic structure of the electronic device involved in the embodiments of the present application. Specifically:

The electronic device may include components such as a processor 801 with one or more processing cores, memory 802 containing computer-readable data, a power supply 803, and an input unit 804. As will be understood by those skilled in the art, the structure of the electronic device shown in FIG. 8 is not intended to limit its scope. The device may incorporate more or fewer components than illustrated, combine certain components, or adopt alternative component arrangements. Specifically:

Processor 801 serves as the control center of the electronic device, connecting all components through various interfaces and wiring. It executes computer programs and/or modules stored in memory 802, processes data stored there, and performs various functions. Optionally, the processor may include one or more processing cores. Preferably, it integrates an application processor and a modem processor. The application processor primarily handles operating systems, user interfaces, and applications, while the modem processor focuses on wireless communication. It should be noted that the aforementioned modem processor may also be omitted from being integrated into the processor 801.

Memory 802 serves as the primary storage medium for computer programs and modules. By executing these stored programs and modules, processor 801 performs various functional applications and data processing tasks. The memory 802 mainly consists of two sections: a program storage area that contains operating systems and essential software for specific functions (e.g., audio playback, video playback), and a data storage area where user-generated electronic content is stored. Additionally, memory 802 may incorporate high-speed random access memory (RAM) and non-volatile storage devices such as disk drives, flash memory, or other volatile solid-state storage solutions. To facilitate processor 801′s access to memory 802, the system also includes a memory controller.

The electronic device also includes a power supply 803 that powers various components. Preferably, the power supply 803 is logically connected to the processor 801 via a power management system, enabling functions such as charging/discharging management and power consumption control. The power supply 803 may further include one or more components such as DC/AC power sources, recharging systems, power failure detection circuits, power converters/inverters, and power status indicators.

The electronic device may also include an input unit 804, which may be used to receive input digital or character information and generate keyboard, mouse, joystick, optical or trackball signal input related to user Settings and function controls.

Although not illustrated, the electronic device may also include display units, among other components, which will not be further elaborated here. Specifically in this embodiment, the processor 801 of the electronic device loads executable files corresponding to the processes of one or more computer programs into memory 802 according to the following instructions. The processor 801 then executes the computer program stored in memory 802, thereby enabling various functions such as:

By controlling the target application in the control device, adding the camera to the target network where the control device is located;

Based on the matter protocol, the target application sends signaling to obtain a request to the camera, so that the camera obtains the first signaling data from the matter data model of the camera based on the signaling request;

The receiving camera receives the first signaling data returned by the target network;

Through the target application, sending the second signaling data of the control device to the camera according to the first signaling data, so that the camera transmits the captured video to the target application through the target network according to the second signaling data.

The specific implementation methods of the above operations and the corresponding beneficial effects can be seen in the detailed description of the video transmission method above, and will not be repeated here.

It will be understood by those skilled in the art that all or some of the steps in the various methods of the above embodiments can be performed by a computer program, or by a computer program controlling the associated hardware, which can be stored on a computer-readable storage medium and loaded and executed by a processor.

To this end, embodiments of the present application provide a computer-readable storage medium storing a computer program that can be loaded by a processor to perform steps in any of the video transmission methods provided by the embodiments of the present application. For example, the computer program may perform the following steps:
through a target application in the control device, adding a camera to a target network where the control device is located;
based on a matter protocol, sending a signaling acquisition request to the camera through the target application, so that the camera obtains a first signaling data of the camera from a matter data model of the camera based on the signaling acquisition request;
receiving the first signaling data returned by the camera through the target network;
through the target application, sending the second signaling data of the control device to the camera according to the first signaling data, so that the camera transmits a captured video to the target application through the target network according to the second signaling data.

The specific implementation methods of the above operations and the corresponding beneficial effects can be seen in the preceding embodiments, and will not be described again here.

The computer-readable storage medium may include, for example, a read-only memory (ROM), random access memory (RAM), disk or optical disc, etc.

Since the computer program stored in the computer-readable storage medium can execute the steps of any video transmission method provided by the embodiments of the present application, the beneficial effects that can be achieved by any video transmission method provided by the embodiments of the present application can be realized. Details are described in the preceding embodiments and will not be repeated here.

According to one aspect of the present application, a computer program product or computer program is provided. The computer program product or computer program includes computer instructions stored in a computer-readable storage medium. A processor of a computer device reads the computer instructions from the computer-readable storage medium and executes them, thereby enabling the computer device to perform the aforementioned video transmission method.

The preceding sections provide a detailed description of the video transmission method, apparatus, electronic device, and computer storage medium disclosed in the embodiments of this application. Specific examples are employed herein to illustrate the principles and implementation methods of the present application. These embodiments are provided solely to facilitate understanding of the methodology and core concepts of this application. Furthermore, technical personnel in the field may modify specific implementations and application scopes based on the principles outlined herein. It should be emphasized that the content of this specification should not be construed as limiting the scope of the present application.

1. A video transmission method, which is applied to a control device, comprising:
through a target application in the control device, adding a camera to a target network where the control device is located;
based on a matter protocol, sending a signaling acquisition request to the camera through the target application, so that the camera obtains a first signaling data of the camera from a matter data model of the camera based on the signaling acquisition request;
receiving the first signaling data returned by the camera through the target network;
through the target application, sending the second signaling data of the control device to the camera according to the first signaling data, so that the camera transmits a captured video to the target application through the target network according to the second signaling data.

2. The video transmission method according to claim 1, wherein the operation of based on a matter protocol, sending a signaling acquisition request to the camera through the target application, so that the camera obtains a first signaling data of the camera from a matter data model of the camera based on the signaling acquisition request, comprises:
based on the matter protocol, sending the signaling acquisition request to the camera through the target application, so that the camera, based on the signaling acquisition request, reads the first signaling data of the camera from a attribute module of the matter data model through a behavior module of the matter data model.

3. The video transmission method according to claim 1, wherein: the operation of through the target application, sending the second signaling data of the control device to the camera according to the first signaling data, so that the camera transmits a captured video to the target application through the target network according to the second signaling data, comprises:
through the target application, generating a streaming media transmission request based on the second signaling data of the control device;
according to the first signaling data, sending the streaming media transmission request to the camera so that the camera transmits the captured video to the target application through the target network according to the second signaling data in the streaming media transmission request.

4. The video transmission method according to claim 1, wherein, before the control device's second signaling data is sent to the camera through the target application based on the first signaling data, the method further comprises:
storing the first signaling data through the matter interaction model;
wherein the operation of through the target application, sending the second signaling data of the control device to the camera according to the first signaling data, so that the camera transmits a captured video to the target application through the target network according to the second signaling data, comprises:
determining whether the control device and the camera are in the target network;
if the control device and the camera are in the target network, reading the first signaling data from the matter interaction model;
through the target application, sending the second signaling data of the control device to the camera according to the first signaling data, so that the camera transmits the captured video to the target application through the target network according to the second signaling data.

5. The video transmission method according to claim 4, wherein: the operation of through the target application, sending the second signaling data of the control device to the camera according to the first signaling data, so that the camera transmits the captured video to the target application through the target network according to the second signaling data, comprises:
acquiring a signaling identifier corresponding to the second signaling data of the control device;
through the target application, sending the signaling identifier to the camera according to the first signaling data, so that the camera determines the second signaling data corresponding to the signaling identifier, and transmits the captured video to the target application through the target network according to the second signaling data.

6. The video transmission method according to claim 1, wherein: the operation of through the target application, sending the second signaling data of the control device to the camera according to the first signaling data, so that the camera transmits a captured video to the target application through the target network according to the second signaling data, comprises:
through the target application, sending the second signaling data of the control device to the camera according to the first signaling data, so that the camera returns the response information to the target application through the target network according to the second signaling data;
verifying the response information by the target application;
if the verification is passed, returning a confirmation message to the camera so that the camera transmits the captured video to the target application through the target network according to the confirmation message.

7. The video transmission method according to any one of claims 1, wherein: the operation of through the target application in the control device, adding the camera to the target network where the control device is located comprises:
through the target application in the control device, sending a certificate acquisition request to the camera;
receiving the target certificate returned by the camera based on the certificate acquisition request;
if the verification of the target certificate is passed, adding the camera to the target network where the control device is located.

8. A video transmission method, which is applied to a camera and the camera and control device are in a target network, comprising:
though a target network, receiving a signaling acquisition request sent by the control device based on the matter protocol through a target application in the control device;
based on the signaling acquisition request, acquiring the first signaling data of the camera from the matter data model of the camera;
returning the first signaling data to the target application through the target network;
through the target network, receiving the second signaling data of the control device returned by the control device through the target application according to the first signaling data;
according to the second signaling data, transmitting the captured video to the target application through the target network.

9. The video transmission method according to claim 8, wherein: the operation of based on the signaling acquisition request, acquiring the first signaling data of the camera from the matter data model of the camera comprises:
based on the signaling acquisition request, reading the first signaling data of the camera from the attribute module of the matter data model of the camera through the behavior module of the matter data model.

10. The video transmission method according to claim 8, wherein: the operation of through the target network, receiving the second signaling data of the control device returned by the control device through the target application according to the first signaling data; according to the second signaling data, transmitting the captured video to the target application through the target network, comprises:
through the target network, receiving a signaling identifier corresponding to the second signaling data of the control device returned by the control device through the target application according to the first signaling data;
determining the second signaling data corresponding to the signaling identifier;
according to the second signaling data, transmitting the captured video to the target application through the target network.

11. The video transmission method according to claim 8, wherein: the operation of according to the second signaling data, transmitting the captured video to the target application through the target network comprises:
according to the second signaling data, return the response information to the target application so that the control device verifies the response information through the target application;
receiving the confirmation information returned by the control device when the verification is passed;
according to the confirmed information, transmitting the collected video to the target application through the target network.

12-18. (canceled)

19. An electronic device, comprising a processor and a memory, the memory storing a computer program, the processor being configured to run the computer program in the memory to perform a video transmission method, the video transmission method comprises: through a target application in the control device, adding a camera to a target network where the control device is located;
based on a matter protocol, sending a signaling acquisition request to the camera through the target application, so that the camera obtains a first signaling data of the camera from a matter data model of the camera based on the signaling acquisition request;
receiving the first signaling data returned by the camera through the target network;
through the target application. sending the second signaling data of the control device to the camera according to the first signaling data, so that the camera transmits a captured video to the target application through the target network according to the second signaling data.

20. (canceled)

21. The electronic device according to claim 19, the processor being further configured to run the computer program in the memory to perform the following operation:
based on the matter protocol, sending the signaling acquisition request to the camera through the target application, so that the camera, based on the signaling acquisition request, reads the first signaling data of the camera from a attribute module of the matter data model through a behavior module of the matter data model.

22. The video transmission method according to claim 19, the processor being further configured to run the computer program in the memory to perform the following operation:
through the target application, generating a streaming media transmission request based on the second signaling data of the control device;
according to the first signaling data, sending the streaming media transmission request to the camera so that the camera transmits the captured video to the target application through the target network according to the second signaling data in the streaming media transmission request.

23. The video transmission method according to claim 19, the processor being further configured to run the computer program in the memory to perform the following operation:
storing the first signaling data through the matter interaction model;
wherein the operation of through the target application, sending the second signaling data of the control device to the camera according to the first signaling data, so that the camera transmits a captured video to the target application through the target network according to the second signaling data, comprises:
determining whether the control device and the camera are in the target network;
if the control device and the camera are in the target network, reading the first signaling data from the matter interaction model;
through the target application, sending the second signaling data of the control device to the camera according to the first signaling data, so that the camera transmits the captured video to the target application through the target network according to the second signaling data.

24. The video transmission method according to claim 23, the processor being further configured to run the computer program in the memory to perform the following operation:
acquiring a signaling identifier corresponding to the second signaling data of the control device;
through the target application, sending the signaling identifier to the camera according to the first signaling data, so that the camera determines the second signaling data corresponding to the signaling identifier, and transmits the captured video to the target application through the target network according to the second signaling data.

25. The video transmission method according to claim 19, the processor being further configured to run the computer program in the memory to perform the following operation:
through the target application, sending the second signaling data of the control device to the camera according to the first signaling data, so that the camera returns the response information to the target application through the target network according to the second signaling data;
verifying the response information by the target application;
if the verification is passed, returning a confirmation message to the camera so that the camera transmits the captured video to the target application through the target network according to the confirmation message.

26. The video transmission method according to any one of claims 19, the processor being further configured to run the computer program in the memory to perform the following operation:
through the target application in the control device, sending a certificate acquisition request to the camera;
receiving the target certificate returned by the camera based on the certificate acquisition request;
if the verification of the target certificate is passed, adding the camera to the target network where the control device is located.
